(19) United States
(12) Patent Application Publication
(10) Pub. No.: US 2005/0161234 A1
(43) Pub. Date: Jul. 28, 2005

(54) Method for suppression and prevention of coal fires

(76) Inventors: Umit Turunc, Doylestown, PA (US); David A. Undlin, Spearfish, SD (US)

Correspondence Address: DUANE MORRIS, LLP;IP DEPARTMENT, ONE LIBERTY PLACE, PHILADELPHIA, PA, 19103-7396, US

(21) Appl. No.: 10/765,739

(22) Filed: Jan. 27, 2004

(51) Int. Cl. A62C 2/00

(52) U.S. Cl. 169/45

(57) ABSTRACT

The present invention relates to a method of inhibiting coal oxidation in a coal pile which includes coating all the surfaces of coal exposed to air with an oxidation inhibiting amount of a composition comprising (a) a water soluble cationic polymer and (b) a wetting agent selected from an anionic or nonionic surfactant, or mixtures thereof.

### FIELD OF THE INVENTION

The present invention relates to the inhibition of coal oxidation. More particularly, the present invention relates to coal oxidation inhibiting compositions comprising aqueous solutions of a combination of water soluble cationic polymers and particular surfactants, and to a method for using the compositions for inhibiting coal oxidation.

### BACKGROUND OF THE INVENTION

Coal is a naturally occurring solid material comprised of mostly amorphous elemental carbon with low percentages of hydrocarbons, complex organic compounds and inorganic material. Coal is mined by surface and underground mining methods. During surface mining operations, large areas of coal are uncovered by removing the overburden (rock, earth, etc.) to facilitate coal extraction. The exposed coal, especially if it is fractured in the form of chunks and powder, is easily oxidized and is also susceptible to self-ignition. A typical area for spontaneous coal fires is at the foot of the highwall; sloughed-off chunks and fine coal can accumulate in piles. These piles can be large enough to retain the heat of oxidation of coal, and coal fires can start.

When coal is exposed to air, the amorphous elemental carbon slowly oxidizes to form CO₂ and heat. Oxidation is accelerated in the presence of moisture and elevated temperature. Oxidation is a detrimental process since it can cause spontaneous combustion, or coal self-ignition. Coal has traditionally been stored in compacted piles to reduce the intrusion of air and moisture and to thereby mitigate the oxidation process. Piling does not halt coal oxidation, but is merely an attempt to slow the oxidation rate. The ideal coal pile is large enough to reduce the surface area of the coal which is exposed to air, yet small enough that heat generated within the coal pile is dissipated into the surrounding environment. Coal fires pose serious dangers to personnel and are costly in terms of damaged equipment and consumed coal. Thus, a continued need exists for a composition and a method for using the composition which inhibits coal oxidation to inhibit coal self-ignition.

Water may be used for extinguishing coal fires and cooling down hot-spots, where oxidation has increased coal temperatures close to self-ignition temperature. Disadvantages associated with the use of water are: (1) the addition of moisture to coal increases the likelihood of coal oxidation, and hence the likelihood of subsequent fires; and (2) coal is difficult to wet, and a great deal of water sprayed on hot spots tends to run off, without penetrating the surface and cooling down the hot spots.

Certain coals, such as lignite or subbituminous coals, are subject to oxidation, self-heating and ignition. This is a major issue in mines, as well as storage areas, such as stockpiles, silos and bins. For example, fires at coal mines are a significant environmental issue, and cause production delays and slowdowns. At present, mines suppress fires by digging them out or burying them with overburden, using mining machinery. It requires deployment of equipment away from production, and it is often not possible to approach the fires close enough with heavy machinery.

It is an object of this invention to provide a composition and a method of using the composition which inhibits the oxidation of coal and thereby also inhibits coal self-ignition. It is a further object of this invention to provide a composition and a method of using the composition which inhibits the oxidation of coal and thereby also inhibits coal self-ignition, whereby effective wetting of the coal surfaces occurs, with no foaming of such surfaces.

### SUMMARY OF THE INVENTION

The present invention relates to compositions and to a method for inhibiting coal oxidation. The coal oxidation inhibiting compositions of the present invention are comprised of treatments including a water soluble cationic polymer anti-oxidant and particular surfactant wetting agents. The preferred cationic polymers are diethylaminetriamine/adipic acid/epichlorohydrin polymers and aminomethylated polyacrylamide. The preferred surfactants are anionic and nonionic in variety. A method of application is to include the treatment in an aqueous solution which is applied as a coating over the exterior surfaces of coal, in an amount effective to inhibit coal oxidation. In the preferred method the treatment is sprayed in situ onto a particular coal pile or any exposed area of coal.

The coal oxidation inhibiting compositions of the present invention are aqueous solutions of water soluble cationic polymers. The polymers may be selected from a wide variety of water-soluble cationic polymers and may be either addition or condensation polymers. Most synthetic cationic polyelectrolytes are polyamine and polyquaternary ammonium salts, although non-nitrogen based cationic polymers are known. Polyamines and polyquaternary amines can be prepared by free-radical chain polymerization, epoxide addition reactions, condensation polymerization and reactions on polymer backbones. Polyamines and polyquaternary anions are also discussed at pp. 489-507 of The Encyclopedia of Polymer Science and Engineering, Vol. 11, Sec. Ed. 1988.

The water soluble cationic polymers are preferably supplied as concentrates which are diluted by mixing with an aqueous solution. The treatment concentration of cationic polymer by weight in the aqueous solution can range from about 0.05% to about 20.0% and is preferably from about 0.1% to about 10.0%. The solution is preferably applied in an aqueous foam. However, the aqueous cationic polymer solutions could be effectively applied as a liquid spray providing adequate coal surface coverage is obtained.

The preferred compositions comprise from about 0.05 to about 20 weight percent water soluble cationic polymer, from about 0.05 to about 5 weight percent wetting agent and from about 75 to about 99.9 weight percent water. The molecular weight of the cationic polymers are preferably from about 100,000 to 5 million and most preferably from 300,000 to 2.5 million. The preferred polymers are diethylaminetriamine/adipic acid/epichlorohydrin polymers and aminomethylated polyacrylamide. The preferred surfactant wetting agents are anionic surfactants, e.g., dioctylsulfosuccinates; mixtures of nonionic and anionic surfactants, e.g., nonylphenol ethoxylates and dioctylsulfosuccinates; or blends of nonylphenol and octylphenol ethoxylates.

The present invention will now be described with respect to specific examples which are to be regarded solely as illustrative and not as restricting the scope of the invention.

### EXAMPLE I

Approximately 3000 gallons of a solution containing 1 wt. % of anti-oxidant (diethylaminetriamine/adipic acid/epichlorohydrin polymer) and 0.1 wt. % of wetting agent (a mixture of anionic (dioctylsulfosuccinate) and non-ionic (nonylphenol ethoxylate) surfactants) was prepared. The solution was sprayed onto two coal fires in the field. Visual observations indicated that there was very little run-off. Upon closer examination after spraying of the treatment, it was apparent that the coal was thoroughly wetted, and the solution had penetrated the coal bed.

While this invention has been described with respect to particular embodiments thereof, it is apparent that numerous other forms and modifications of the invention will be obvious to those skilled in the art. The appended claims and this invention generally should be construed to cover all such obvious forms and modifications which are within the true spirit and scope of the present invention.

1. A method of inhibiting coal oxidation in a coal pile comprising coating all surfaces of coal exposed to air with an oxidation inhibiting amount of a composition comprising (a) a water soluble cationic polymer and (b) a wetting agent selected from an anionic or nonionic surfactant, or mixtures thereof.

2. The method as recited in claim 1, wherein said composition is effective to inhibit coal self-ignition.

3. The method as recited in claim 1, wherein said cationic polymer is diethylaminetriamine/adipic acid/epichlorohydrin polymer or aminomethylated polyacrylamide.

4. The method as recited in claim 3, wherein from about 0.05 weight percent to about 20 weight percent of said composition is diethylaminetriamine/adipic acid/epichlorohydrin polymer or aminomethylated polyacrylamide and from about 75 weight percent to about 99.9 weight percent of said composition is water.

5. The method as recited in claim 4, wherein said composition comprises from about 0.05 to about 5 weight percent anionic surfactant.

6. The method as recited in claim 5, wherein said anionic surfactant is a dioctylsulfosuccinate.

7. The method as recited in claim 1, wherein said mixture of nonionic and anionic surfactants is a mixture of nonylphenol ethoxylates and dioctylsulfosuccinates.

8. The method as recited in claim 1, wherein said nonionic surfactant is a blend of nonylphenol and octylphenol ethoxylates.

9. The method as recited in claim 1, wherein said composition is applied without a foaming agent.
